(19) United States
(12) Patent Application Publication
(10) Pub. No.: US 2026/0336362 A1
(43) Pub. Date: Oct. 29, 2026

(54) SYSTEMS FOR MANAGING HEATING AND COOLING IN VEHICLES

(71) Applicant: Rivian IP Holdings, LLC, Irvine, CA (US)

(72) Inventors: Yanping XIA, Irvine, CA (US); Wen LIU, Northville, MI (US); Lingyan JIANG, Irvine, CA (US); Jing HE, Novi, MI (US)

(21) Appl. No.: 19/193,859

(22) Filed: Apr. 29, 2025

(51) Int. Cl. B60H 1/00

(52) U.S. Cl. CPC B60H 1/00921; B60H 1/00278; B60H 2001/00307; B60H 2001/00928

(57) ABSTRACT

A system for a vehicle may operate in several modes. For example, the system may operate in a mode to heat or cool the vehicle. The system may operation in another mode to cool a powertrain or energy storage system of the vehicle. The system may rely on a receiver-drier on a high pressure side of a compressor, which allows for efficient heating/cooling performance.

### INTRODUCTION

This application is directed to vehicles, and more particularly, to enhanced heating and cooling of vehicles.

### SUMMARY

The subject technology is directed heating and cooling of cabins in vehicles. In some example implementations, an accumulator bottle is removed from a fluid circuit to reduce suction side fluid pressure drop and enhance cooling performance.

The subject technology is directed heating and cooling of cabins in vehicles. In some example implementations, an accumulator bottle is removed from a fluid circuit to reduce suction side fluid pressure drop and enhance cooling performance.

In one or more aspects of the present disclosure, an apparatus is described. The apparatus may include a system. The system may include a chiller configured to receive a first fluid. The system may further include a compressor in fluid communication with the chiller. The chiller may be upstream to the compressor and causes in part a first pressure of a second fluid. The system may further include a receiver-drier downstream to the compressor and causes in part a second pressure of the second fluid. The second pressure may be greater than the first pressure.

The apparatus may further include a condenser. In a first mode of operation the chiller may be configured to receive the first fluid from a radiator, and provide the second fluid to the condenser to heat a cabin of a vehicle.

The apparatus may further include a valve. In a second mode of operation, the valve may be open, causing: a first portion of the second fluid to pass through the condenser and the receiver-drier, and a second portion of the second fluid to pass through the valve. In the second mode of operation, the first portion of the second fluid may be configured to merge with the second portion of the second fluid at the chiller. The chiller may include a chiller pump, and in the second mode of operation, the chiller pump may be in an inactive state.

In a third mode of operation, the chiller may be configured to receive the first fluid from at least one of a powertrain of a vehicle or an energy storage system of the vehicle.

The apparatus may further include a condenser downstream to the compressor. The apparatus may further include a first valve. In a fourth mode of operation, the first valve may be opened to remove a portion of the second fluid, prior to the second fluid passing through the receiver-drier, and provide the portion of the second fluid to the condenser. The apparatus may further include a second valve. In a fifth mode of operation, the first valve may be closed and the second valve opened to provide the portion of the second fluid to the receiver-drier.

In one or more aspects of the present disclosure, a method is described. The method may include providing, via a first valve, a first fluid from a radiator to a chiller. The method may further include providing, from the chiller, a second fluid to a compressor in fluid communication with the chiller via a second fluid line. The chiller may be upstream to the compressor and causes in part a first pressure of the second fluid. The method may further include providing, from the compressor, the second fluid to a receiver-drier downstream to the compressor and causes in part a second pressure of the second fluid. The second pressure may be greater than the first pressure.

The method may further include, in a first mode of operation: receiving, by the chiller and from a radiator, the first fluid; and closing a second valve, thereby causing the second fluid to pass through a condenser to heat a cabin of a vehicle.

The method may further include, in a second mode of operation, opening the second valve, thereby causing: a first portion of the second fluid to pass through the condenser and the receiver-drier, and a second portion of the second fluid to pass through the second valve. In the second mode of operation, the first portion of the second fluid may be configured to merge with the second portion at the chiller. The method may further include, in the second mode of operation, placing a chiller pump of the chiller pump in an inactive state.

The method may further include, in a third mode of operation, receiving, by the chiller, the first fluid from at least one of a drive unit of a vehicle or a drive unit battery of the vehicle.

The method may further include, in a fourth mode of operation: opening a second valve may be opened to remove a portion of the second fluid prior to the second fluid passing through the receiver-drier; and providing the portion to a condenser.

The method may further include, in a fifth mode of operation: closing the second valve; and opening a third valve to provide the portion of the second fluid to the receiver-drier.

In one or more aspects of the present disclosure, a vehicle is described. The vehicle may include a cabin. The vehicle may further include a system configured to heat and cool the cabin. The system may include a chiller configured to receive a first fluid from a radiator. The system may further include a compressor in fluid communication with the chiller. The chiller may be upstream to the compressor and causes in part a first pressure of a second fluid. The system may further include a receiver-drier downstream to the compressor and causes in part a second pressure of the second fluid. The second pressure may be greater than the first pressure.

The vehicle may further include a valve. The vehicle may further include a condenser. In a first mode of operation: the chiller configured to receive the first fluid from a radiator, and the valve may be closed, causing the second fluid to pass through the condenser to heat a cabin of a vehicle. In a second mode of operation, the valve may be open, causing: a first portion of the second fluid to pass through the condenser and the receiver-drier, and a second portion of the second fluid to pass through the valve. In the second mode of operation, the first portion of the second fluid may be configured to merge with the second portion of the second fluid.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a side view of an example of a vehicle, in accordance with aspects of the present disclosure.

FIG. 2 illustrates a side view of an alternate example of a vehicle, in accordance with aspects of the present disclosure.

FIG. 3A illustrates a schematic diagram of a valve, operating in a mode of operation, in accordance with aspects of the present disclosure.

FIG. 3B illustrates a schematic diagram of a system, operating in a mode of operation, in accordance with aspects of the present disclosure.

FIG. 4 illustrates a schematic diagram of a system operating in an alternate mode of operation, in accordance with aspects of the present disclosure.

FIG. 5A illustrates a schematic diagram of a valve, operating in yet another alternate mode of operation, in accordance with aspects of the present disclosure.

FIG. 5B illustrates a schematic diagram of a system operating in yet another alternate mode of operation, in accordance with aspects of the present disclosure.

FIG. 6 illustrates a schematic diagram of a system operating in yet another an alternate mode of operation, in accordance with aspects of the present disclosure.

FIG. 7 illustrates a schematic diagram of a system operating in yet another an alternate mode of operation, in accordance with aspects of the present disclosure.

FIG. 8 illustrates a schematic diagram of a system operating in yet another an alternate mode of operation, in accordance with aspects of the present disclosure.

FIG. 9 illustrates a schematic diagram of a system operating in yet another an alternate mode of operation, in accordance with aspects of the present disclosure.

FIG. 10 illustrates a block diagram of a vehicle, in accordance with aspects of the present disclosure.

FIG. 11 illustrates a flow diagram showing an example of a process that may be performed for managing fluid in a system, in accordance with implementations of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to systems for cabin vehicles, as well as for cooling other components (e.g., powertrain, energy storage system). An accumulator bottle is traditionally found in a fluid circuit of a system. However, for systems shown and described herein, the accumulator bottle is removed. Moreover, a receiver-drier replaces the accumulator bottle and is replaced on the high side (e.g., high temperature, high pressure) of the compressor, which may be downstream to the compressor. By locating the receiver-drier downstream to the compressor, the pressure at the low side (e.g., high temperature, low pressure) of the compressor is reduced, which may enhance heating and cooling performance for vehicles. Several modes (e.g., cooling mode, heating mode, dehumidifier mode, waste heat removal mode) may be implement using system shown and described while removing the accumulator bottle from the fluid circuit.

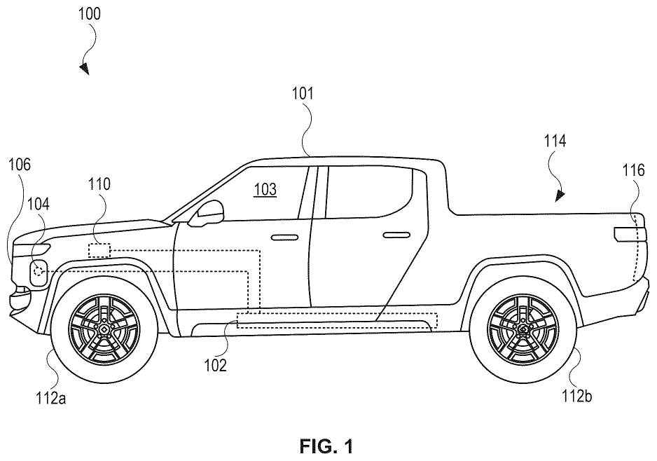

FIG. 1 illustrates a side view of an example of a vehicle 100, in accordance with one or more aspects of the present disclosure. In the example shown in FIG. 1, the vehicle 100 takes the form of a truck. Generally, the vehicle 100 may take the form of any motorized vehicle, including motorized vehicles with an internal combustion engine and/or one or more electric motors. Accordingly, other implementations of the vehicle 100 may include land-based vehicles, such as a car (e.g., sedan, hatchback), a van, or a commercial truck, as non-limiting examples.

The vehicle 100 may include a battery pack 102. The battery pack 102 may be carried by a vehicle body 101 of the vehicle 100, with the vehicle body 101 defining a cabin 103 that provides a space for passengers. The battery pack 102 may be coupled (e.g., electrically coupled) to one or more electrical systems of the vehicle 100 to provide power to the one or more electrical systems. For example, the vehicle 100 may include a port 104 (e.g., charge port) designed to receive a cable connector (not shown in FIG. 1) used to transmit power (e.g., alternating current (AC) power) that is converted to direct current (DC) power to charge the battery pack 102. The vehicle 100 may further include a front end 106 at which one or more lamps (shown below) are generally positioned.

As another exemplary electrical system, the vehicle 100 may include a drive unit 110, representative of one or more additional drive units of the vehicle 100. The battery pack 102 may couple to the drive unit 110. While the drive unit 110 is shown as generally being in the front of the vehicle 100, the drive unit 110 may be located in the rear of the vehicle 100. Further, when multiple drive units are used, at least one drive unit may be in the front of the vehicle 100 to drive the front wheels (e.g., wheel 112a), and at least one drive unit may be in the rear of the vehicle 100 to drive the rear wheels (e.g., wheel 112b). The drive unit 110 may include, for example, a motor, an inverter, a gear box, and a differential. In the example shown in FIG. 1, the drive unit 110 takes the form of an electric motor. In this regard, the drive unit 110 may use energy (e.g., electrical energy) stored in the battery pack 102 for propulsion in order to drive (e.g., rotationally drive) wheels of the vehicle 100.

The vehicle 100 may further include a bed 114 that may be used as a storage area for the vehicle 100. In order to access the bed 114, the vehicle 100 may further include a gate 116. Based on its position on the vehicle 100, the gate 116 may take the form of a closure, such as a rear gate or a tailgate. The gate 116 is designed to open, via rotation, thereby allowing further access to the bed 114.

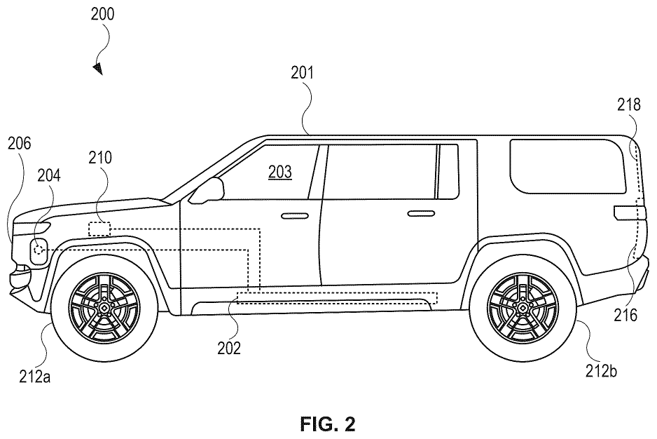

FIG. 2 illustrates a side view of an alternate example of a vehicle 200, in accordance with one or more aspects of the present disclosure. As shown, the vehicle 200 takes the form of a sport utility vehicle (SUV). The vehicle 200 may include several features shown and/or described for the vehicle 100 (shown in FIG. 1). For example, the vehicle 200 may include a vehicle body 201, a battery pack 202, a cabin 203, a port 204 (e.g., charge port), a front end 206, a drive unit 210 (representative of one or more additional drive units), a wheel 212a (representative of an additional front wheel), and a wheel 212b (representative of an additional rear wheel).

The cabin 203 of the vehicle 200 may extend to a rear portion of the vehicle 200. In order to access the rear portion of the cabin 203, the vehicle 200 may further include a gate 216. Based on its position on the vehicle 200, the gate 216 may take the form of a rear gate or a liftgate. The gate 216 is designed to open, via rotation, thereby allowing access to the cabin 203. Additionally, the vehicle 200 may include an enclosure 218. In one or more implementations, the enclosure 218 takes the form of a glass panel. Similar to the gate 216, the enclosure 218 is designed to open, via rotation, thereby allowing further access to the cabin 203.

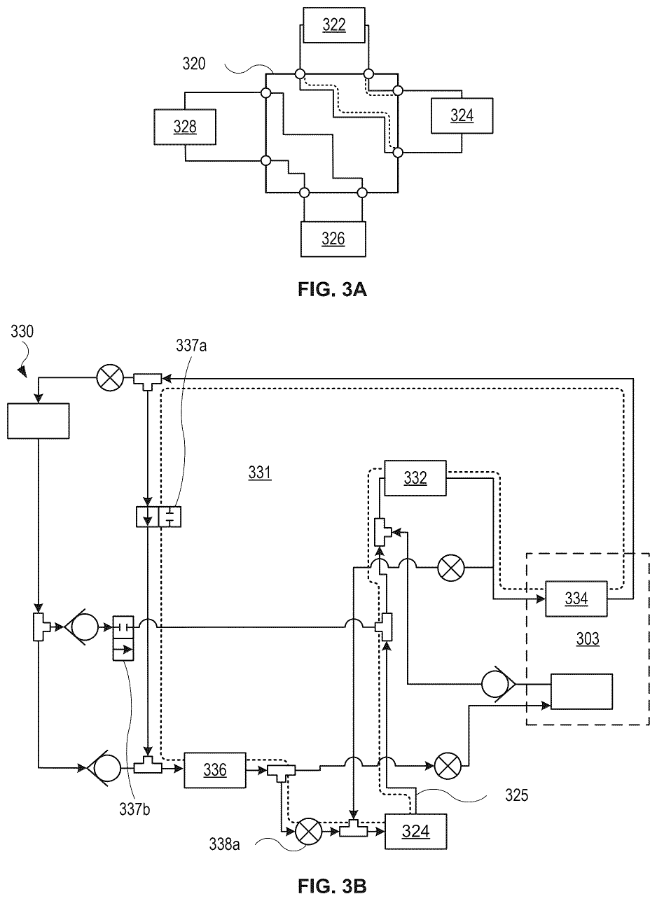

FIG. 3A illustrates a schematic diagram of a valve 320, operating in a mode of operation, in accordance with aspects of the present disclosure. The valve 320 may take the form of a multi-port valve, including includes eight ports (as a non-limiting example). The valve 320 may connect, at two ports of the valve 320, to a radiator 322. Further, the valve 320 may connect, at two ports of the valve 320, to a chiller 324.

The valve 320, the radiator 322, and the chiller 324 may be implemented in a vehicle (e.g., vehicle 100 or vehicle 200 shown in FIGS. 1 and 2, respectively). In a mode of operation (e.g., a first mode of operation), the radiator 322 functions as a heat exchanger to extract heat from one form of fluid (e.g., air source) and provide the heat to another form of fluid (e.g., coolant, refrigerant). The fluid (e.g., coolant, refrigerant) is subsequently transferred to the chiller 324 via the valve 320.

The valve 320 may be further connected to an energy storage system 326 (or ESS) that provides energy to a vehicle, similar to the battery pack 102 shown in FIG. 1. The valve 320 may be further connected to a powertrain 328 that provides propulsion to a vehicle. The powertrain 328 may include a drive unit (e.g., electric motor(s)) and a differential, as non-limiting examples.

FIG. 3B illustrates a schematic diagram of a system 330 operating in a mode of operation, in accordance with aspects of the present disclosure. The system 330 may take the form of a heat pump system incorporated into a heating, venting, and air conditioning (HVAC) system. In this regard, the system 330 may be characterized as a fluid circuit. The mode of the system 330 in FIG. 3B may include a heating mode. A first fluid (Fluid 1) circulates through the fluid circuit in FIG. 3A, while a second fluid (Fluid 2) circulates through the fluid circuit in FIG. 3B (e.g., through a loop 331). The chiller 324 (shown in both FIGS. 3A and 3B) functions as a heat exchanger to exchange heat between Fluid 1 and Fluid 2. The chiller 324 (also shown in FIG. 3A) extracts the heat from the received Fluid 1 (e.g., (e.g., coolant, refrigerant) and provides a relatively warmer fluid (Fluid 2) into the system 330 in a loop 331 (e.g., fluid loop shown as dotted lines). For example, the fluid may pass from the chiller 324 and into a compressor 332 in communication with the chiller 324 via a fluid line 325 (representative of one or more fluid lines of the system 330). The compressor 332 may compress and pump the cooling fluid based on the desired needs of the passengers of the vehicle. The fluid may then pass into a condenser 334 to provide heating for a cabin 303 (e.g., where the passengers may be located) of the vehicle.

The fluid (Fluid 2) may pass, via a valve 337a, from the condenser 334 to a receiver-drier 336 in fluid communication with the condenser 334 and with the compressor 332. In one or more implementations, the valve 337a takes the form of a shut-off valve. The system 330 may further include a valve 337b, which may take the form of a shut-off valve. As shown, the valve 337a is in the open position and the valve 337b is in the closed position. The receiver-drier 336 may filter the cooling fluid prior to the fluid passing through a valve 338a of the system 330. The valve 338a may take the form of an expansion valve used to reduce the pressure of the received fluid. As shown, the receiver-drier 336 is downstream to the compressor 332. The term “downstream” as used in this detailed description and in the claims refers to a component (e.g., the receiver-drier 336) situated in the direction of flow of a fluid (e.g. Fluid 2) to another component (e.g., compressor 332). Also, the receiver-drier 336 is located in the system 330 on the high side (e.g., high temperature, high pressure) of the compressor 332. Conversely, the chiller 324 is upstream to the compressor 332 and is located in the system 330 on the low side (e.g., low temperature, low pressure) of the compressor 332. The term “upstream” as used in this detailed description and in the claims refers to a component (e.g., the chiller 324) situated in the opposite direction of flow of a fluid (e.g. Fluid 2) to another component (e.g., compressor 332). Accordingly, the receiver-drier 336 may receive fluid at a higher pressure than that of the chiller 324. The valve 338a, used as an expansion valve, may reduce the pressure of the received fluid through the receiver-drier 336, prior to the fluid returning to the chiller 324. The fluid (Fluid 1), after releasing heat at the chiller 324 and becoming a colder fluid, may further flow into the radiator 322 (shown in FIG. 3A), and may absorb heat from ambient air that is propelled by the radiator fan and flowing through the radiator air passage. Further, tased on their respective locations, the valve 337a and the valve 337b may be referred to as a high side valve (including a high side shut-off valve) and a low side valve (including a low side shut-off valve), respectively.

Using the receiver-drier 336 on the relatively high pressure side of the compressor 332, the system 330 (e.g., shown and described in various implementations in FIG. 3 through FIG. 9) does not require components such as an accumulator bottle on the low pressure side of the compressor 332. In this regard, the system 330 may not undergo significant low side pressure drop at the compressor 332. Moreover, the system 330 may operate with the same performance, including without changes to the fluid charge, despite not having an accumulator bottle. Additionally, the system 330 may provide enhanced performance (e.g., enhanced cooling performance, enhanced heating performance) for vehicles.

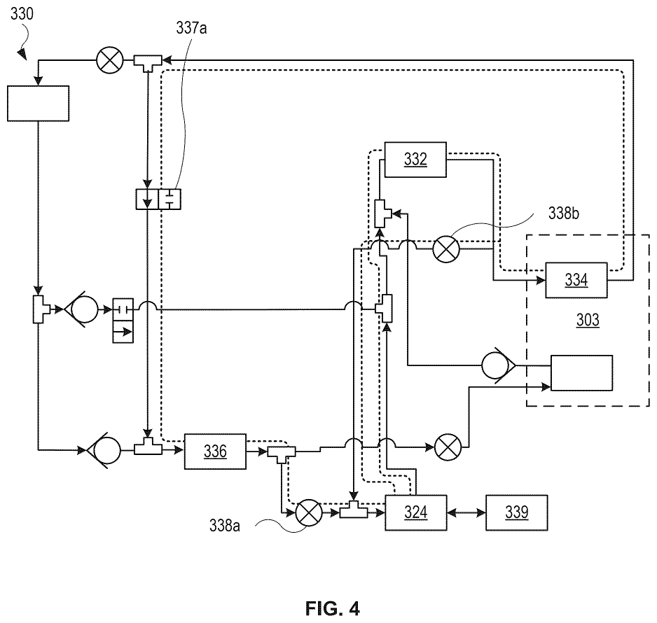

FIG. 4 illustrates a schematic diagram of the system 330 operating in an alternate mode of operation, in accordance with aspects of the present disclosure. The mode of operation (e.g., a second mode of operation) the system 330 in FIG. 4 may include a compressor heat boost mode that uses compressible air to generate hot gas for heating. The chiller 324 may include a chiller pump 339 that is placed in an inactive state in this mode of operation. As shown, some portion of the fluid (shown as dotted lines) may flow out the compressor 332 and to the condenser 334 in order to, for example, provide heat to the cabin 303. Another portion of the fluid may flow from the compressor 332 and through a valve 338b that takes the form of an expansion valve. The fluid may flow, via the valve 338b (in the open position), to the chiller 324. Also, the fluid from the condenser 334 may flow, via the valve 337a, through the receiver-drier 336, the valve 338b, and to the chiller 324. The fluid (Fluid 2), through the different paths, may merge at the chiller 324 at different states (e.g., a liquid and a gas), and subsequently back to the compressor 332.

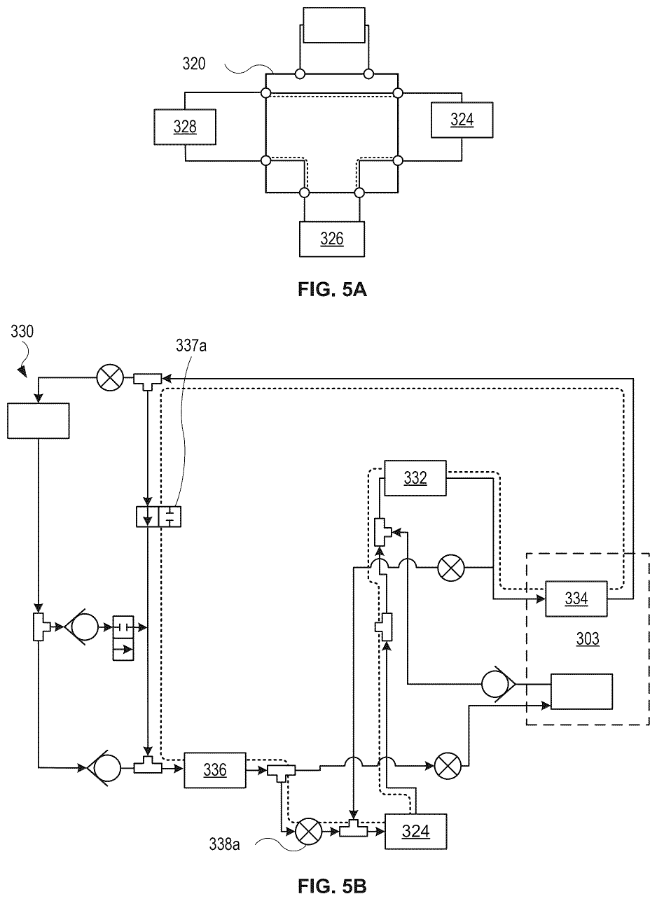

FIG. 5A illustrates a schematic diagram of a valve 320, operating an alternate mode of operation, in accordance with aspects of the present disclosure. During operation of a vehicle, the energy storage system 326 and/or the powertrain 328 may generate heat, which may be carried to the chiller 324 via the valve 320. Accordingly, the valve 320 may place the energy storage system 326 and the powertrain 328 in fluid communication with the chiller 324.

FIG. 5B illustrates a schematic diagram of a system 330 operating in an alternate mode of operation, in accordance with aspects of the present disclosure. The mode of operation (e.g., a third mode of operation) of the system 330 in FIG. 3B may include a heat waste mode (e.g., to remove waste heat from the energy storage system 326 and/or the powertrain 328 shown in FIG. 5A). The chiller 324 (also shown in FIG. 5A) extracts the heat from the received heated fluid (Fluid 1) and provides a relatively warmer fluid (Fluid 2) into the system 330 in a loop (shown as dotted lines). In this regard, the fluid (Fluid 2) may pass from the chiller 324 and into the compressor 332, from the compressor 332 to the condenser 334, from the condenser 334 to the receiver-drier 336 via the valve 337a, and from the receiver-drier 336 back to the chiller 324. In this mode of operation, the system 330 may be used to remove heat from the energy storage system 326 and/or the powertrain 328, and provide heating for the cabin 303.

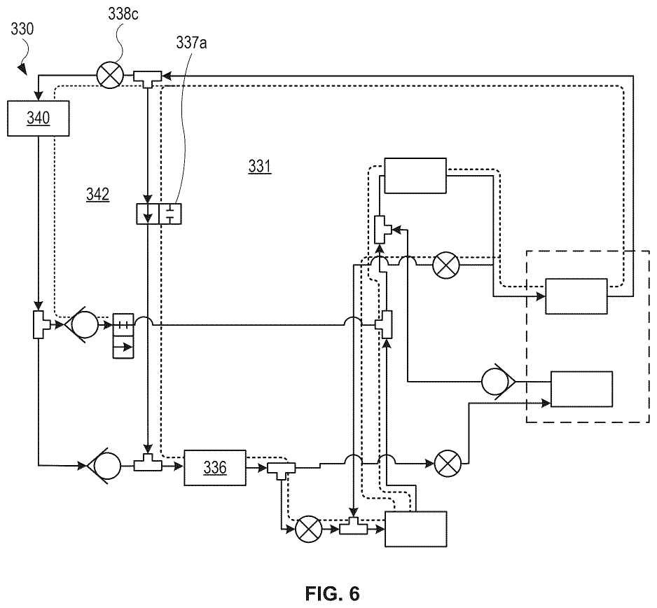

FIG. 6 illustrates a schematic diagram of the system 330 operating in an alternate mode of operation, in accordance with aspects of the present disclosure. As shown, the system 330 may include a valve 338c that takes to form of an expansion valve. In some instances, the system 330 includes more fluid in the loop 331 than desired. In this regard, the valve 338c may open, allowing at least some of the fluid to be removed from the loop 331 and enter a condenser 340 via a sub-loop 342 (shown as dotted lines). In this regard, the fluid exiting the loop 331 (e.g., into the sub-loop 342) may be provided to the condenser 340 prior to the fluid passing through the receiver-drier 336 via the valve 337a. Additionally, opening (e.g., including briefly opening) the valve 338c may relieve and reduce some of the pressure due to the fluid. When the valve 338c is closed, the fluid may become trapped in a sub-loop 342, including in a condenser 340 of the system 330. This mode of operation (e.g., a fourth mode of operation) may be referred to as a fluid trapping mode.

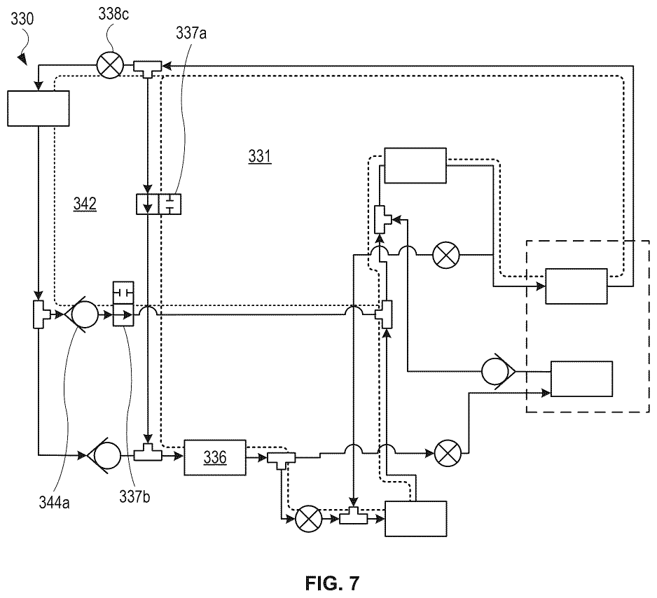

FIG. 7 illustrates a schematic diagram of the system 330 operating in an alternate mode of operation, in accordance with aspects of the present disclosure. In some instances, at least some of the fluid in the sub-loop 342 may be provided back into the loop 331. In this regard, the system 330 may include a valve 344a that takes the form of a check valve. In one or more implementations, the valve 344a and the valve 337b may be opened (including while the valve 338c is closed), thereby allowing fluid in the sub-loop 342 to re-enter the loop 331 and enter the receiver-drier 336. This mode of operation (e.g., a fifth mode of operation) may be referred to as a fluid flushing mode.

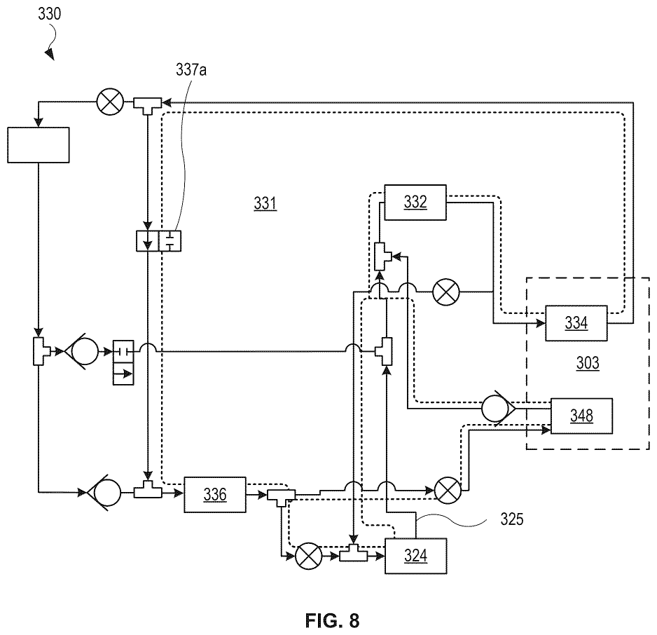

FIG. 8 illustrates a schematic diagram of the system 330 operating in an alternate mode of operation, in accordance with aspects of the present disclosure. The mode of operation (e.g., a sixth mode of operation) of the system 330 in FIG. 8 may include a dehumidification mode (e.g., to dehumidify windshield(s) of a vehicle). The system 330 may further include an evaporator 348. As shown, the evaporator 348 is in parallel with the chiller 324. Additionally, the fluid may pass through the loop 331 from the chiller 324 and into the compressor 332 in communication with the chiller 324 via the fluid line 325 (representative of one or more fluid lines of the system 330). The fluid may then pass into a condenser 334 to provide dehumidification for the cabin 303. The fluid may pass, via the valve 337a, from the condenser 334 to the receiver-drier 336 in fluid communication with the condenser 334 and with the compressor 332. The receiver-drier 336 may filter the cooling fluid prior to the fluid passing through the valve 338a of the system 330 and to a heat exchanger.

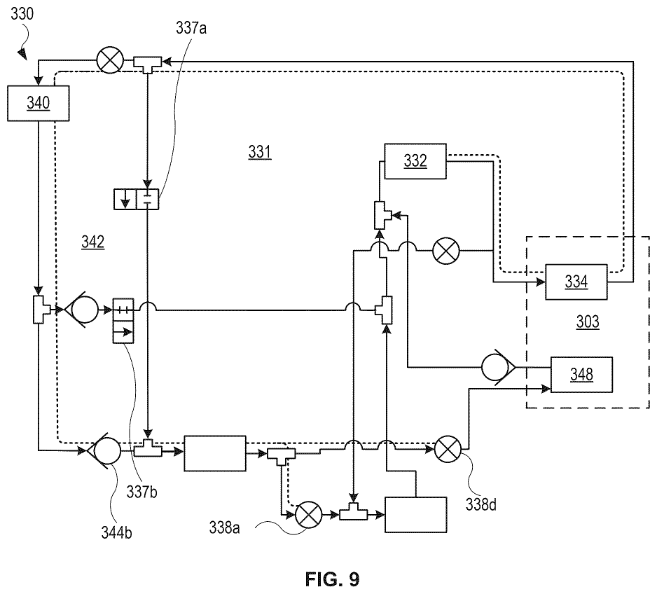

FIG. 9 illustrates a schematic diagram of the system 330 operating in an alternate mode of operation, in accordance with aspects of the present disclosure. The mode of operation (e.g., a seventh mode of operation) the system 330 in FIG. 8 may include a dual cooling mode. As shown, the fluid may flow out of the compressor 332 and to the condenser 334, and subsequently through the condenser 340 via the valve 338c in an open position. The system 330 may further include a valve 344b that takes the form of a check valve, as well as a valve 338d that takes the form of a expansion valve. The fluid may flow through the valve 344b, when open, and to the valve 338a. In this regard, both the valve 337a and the valve 337b may be closed.

The system 330 may be used to cool one or more components. For example, when the valve 338a is open and the valve 338d is closed, fluid may flow to the energy storage system 326 (shown in FIG. 3A) and the energy storage system 326 may be cooled. Conversely, when the valve 338a is closed and the valve 338d is open, fluid may flow to the evaporator 348 and the cabin 303 may be cooled. Further, when the valve 338a is open and the valve 338d is open, both the cabin 303 and the energy storage system 326 may be cooled.

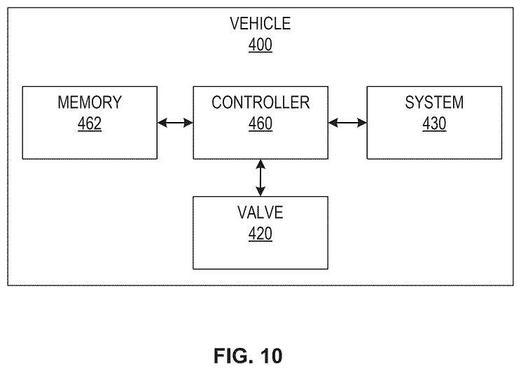

FIG. 10 illustrates a block diagram of a vehicle 400, in accordance with aspects of the present disclosure. The vehicle 400 may take the form of any vehicle(s) shown and/or described herein. The vehicle 400 may include a valve 420 (e.g., multi-port valve) and a system 430 (e.g., heat pump system). The valve 420 and the system 430 may include any features (e.g., including modes) shown and/or described herein for the valve 320 (e.g., shown in FIG. 3A) and the system 330 (e.g., shown in FIG. 3B).

The vehicle 400 may include a controller 460 designed to operate the system 430, including placing the system 430 and its components in certain configurations based on a particular mode of operation shown and/or described herein. The controller 460 may include one or more processors in the form of a central processing unit, a microelectromechanical system (MEMS), one or more microcontrollers, or a combination thereof. The vehicle 400 may further include memory 462 that stores executable instructions on RAM (Random Access Memory) and/or ROM (Read-Only Memory), with the executable instructions for use by the controller 460 to operate the valve 420 and the system 430.

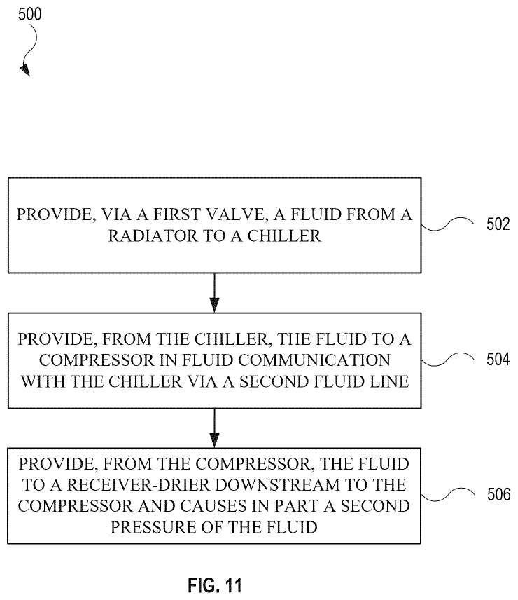

FIG. 11 illustrates a flow diagram showing an example of a process 500 that may be performed for managing fluid in a system, in accordance with implementations of the subject technology. For explanatory purposes, the process are primarily described herein with reference to a valve(s) and a system shown in one or more FIGS. 3A-9. However, the process are not limited to the valve(s) and the system shown in one or more FIGS. 3A-9, and one or more blocks (or operations) of the process may be performed by one or more other components of other suitable moveable apparatuses, devices, or systems. Further for explanatory purposes, some of the blocks of the process are described herein as occurring in serial, or linearly. However, multiple blocks of the process may occur in parallel. In addition, the blocks of the process need not be performed in the order shown and/or one or more blocks of the process need not be performed and/or can be replaced by other operations.

At block 502, providing, via a first valve, a fluid (e.g., coolant, refrigerant) is provided via a first valve (e.g., valve 320 shown in FIG. 3A) from a radiator (e.g., radiator 322 shown in FIG. 3A) to a chiller (e.g., chiller 324 shown in FIGS. 3A and 3B).

At block 504, the fluid is provided, from the chiller, a compressor (e.g., compressor 332) in fluid communication with the chiller via a second fluid line. The chiller may be upstream to the compressor and causes in part a first pressure (e.g., low side pressure) of the fluid.

At block 506, the fluid is provided, from the compressor, to a receiver-drier (e.g., receiver-drier 336) downstream to the compressor and causes in part a second pressure (e.g., high side pressure) of the fluid. The second pressure may be greater than the first pressure.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus, comprising:
a system comprising:
a chiller configured to receive a first fluid;
a compressor in fluid communication with the chiller, wherein the chiller is upstream to the compressor and causes in part a first pressure of a second fluid; and
a receiver-drier downstream to the compressor and causes in part a second pressure of the second fluid, wherein the second pressure is greater than the first pressure.

2. The apparatus of claim 1, further comprising:
a condenser, wherein in a first mode of operation the chiller is configured to:
receive the first fluid from a radiator, and
provide the second fluid to the condenser to heat a cabin of a vehicle.

3. The apparatus of claim 2, further comprising a valve, wherein in a second mode of operation, the valve is open, causing:
a first portion of the second fluid to pass through the condenser and the receiver-drier, and
a second portion of the second fluid to pass through the valve.

4. The apparatus of claim 3, wherein in the second mode of operation, the first portion of the second fluid is configured to merge with the second portion of the second fluid at the chiller.

5. The apparatus of claim 3, wherein the chiller comprises a chiller pump, and in the second mode of operation, the chiller pump is in an inactive state.

6. The apparatus of claim 1, wherein in a third mode of operation, the chiller is configured to receive the first fluid from at least one of a powertrain of a vehicle or an energy storage system of the vehicle.

7. The apparatus of claim 1, further comprising:
a condenser downstream to the compressor; and
a first valve, wherein in a fourth mode of operation, the first valve is opened to remove a portion of the second fluid, prior to the second fluid passing through the receiver-drier, and provide the portion of the second fluid to the condenser.

8. The apparatus of claim 7, further comprising a second valve, wherein in a fifth mode of operation, the first valve is closed and the second valve opened to provide the portion of the second fluid to the receiver-drier.

9. A method, comprising:
providing, via a first valve, a first fluid from a radiator to a chiller;
providing, from the chiller, a second fluid to a compressor in fluid communication with the chiller via a second fluid line, wherein the chiller is upstream to the compressor and causes in part a first pressure of the second fluid; and
providing, from the compressor, the second fluid to a receiver-drier downstream to the compressor and causes in part a second pressure of the second fluid, wherein the second pressure is greater than the first pressure.

10. The method of claim 9, further comprising, in a first mode of operation:
receiving, by the chiller and from a radiator, the first fluid; and
closing a second valve, thereby causing the second fluid to pass through a condenser to heat a cabin of a vehicle.

11. The method of claim 10, further comprising, in a second mode of operation, opening the second valve, thereby causing:
a first portion of the second fluid to pass through the condenser and the receiver-drier, and
a second portion of the second fluid to pass through the second valve.

12. The method of claim 11, wherein in the second mode of operation, the first portion of the second fluid is configured to merge with the second portion at the chiller.

13. The method of claim 11, further comprising, in the second mode of operation, placing a chiller pump of the chiller pump in an inactive state.

14. The method of claim 9, further comprising, wherein in a third mode of operation, receiving, by the chiller, the first fluid from at least one of a drive unit of a vehicle or a drive unit battery of the vehicle.

15. The method of claim 9, further comprising, in a fourth mode of operation:
opening a second valve is opened to remove a portion of the second fluid prior to the second fluid passing through the receiver-drier; and
providing the portion to a condenser.

16. The method of claim 15, further comprising, in a fifth mode of operation:
closing the second valve; and
opening a third valve to provide the portion of the second fluid to the receiver-drier.

17. A vehicle, comprising:
a cabin; and
a system configured to heat and cool the cabin, the system comprising:
a chiller configured to receive a first fluid from a radiator;
a compressor in fluid communication with the chiller, wherein the chiller is upstream to the compressor and causes in part a first pressure of a second fluid; and
a receiver-drier downstream to the compressor and causes in part a second pressure of the second fluid, wherein the second pressure is greater than the first pressure.

18. The vehicle of claim 17, further comprising:
a valve; and
a condenser, wherein in a first mode of operation:
the chiller is configured to receive the first fluid from a radiator, and
the valve is closed, causing the second fluid to pass through the condenser to heat a cabin of a vehicle.

19. The vehicle of claim 18, wherein in a second mode of operation, the valve is open, causing:
a first portion of the second fluid to pass through the condenser and the receiver-drier, and
a second portion of the second fluid to pass through the valve.

20. The vehicle of claim 19, wherein in the second mode of operation, the first portion of the second fluid is configured to merge with the second portion of the second fluid.
